(19) United States
(12) Patent Application Publication
(10) Pub. No.: US 2025/0060891 A1
(43) Pub. Date: Feb. 20, 2025

(54) METHOD OF OPERATING STORAGE DEVICE AND STORAGE DEVICE PERFORMING THE SAME

(71) Applicant: Samsung Electronics Co., Ltd., Suwon-si (KR)

(72) Inventors: Sunghwan SIM, Suwon-si (KR); Yonghwan KWAK, Suwon-si (KR); Jongsung NA, Suwon-si (KR); Joonyeop PARK, Suwon-si (KR)

(73) Assignee: Samsung Electronics Co., Ltd., Suwon-si (KR)

(21) Appl. No.: 18/428,202

(22) Filed: Jan. 31, 2024

(30) Foreign Application Priority Data
Aug. 16, 2023 (KR) 10-2023-0106960

(51) Int. Cl. G06F 3/06

(52) U.S. Cl. CPC G06F 3/064; G06F 3/0616; G06F 3/0652; G06F 3/0679

(57) ABSTRACT

A method of operating a storage device including a plurality of meta blocks that store a plurality of metadata includes: receiving a first command from a host device; obtaining a plurality of characteristic values including first to fourth characteristic values, and a degradation index for each of the plurality of meta blocks based on the first command; and outputting a first response corresponding to the first command. The first command is for detecting an abnormal state of the storage device, the first characteristic value is related to an endurance characteristic, the second characteristic value is related to a data retention characteristic, the third characteristic value is related to a read disturbance characteristic, the fourth characteristic value is related to a temperature characteristic, the degradation index is calculated from the plurality of characteristic values, and the first response is generated based on at least one of the first characteristic value or the degradation index.

### REFERENCE TO PRIORITY APPLICATION

This application claims priority under 35 USC § 119 to Korean Patent Application No. 10-2023-0106960, filed Aug. 16, 2023, the contents of which is hereby incorporated herein by reference in its entirety.

### BACKGROUND

### 1. Technical Field

Example embodiments relate to memory devices, and more particularly, methods of operating storage devices and storage devices performing the methods.

### 2. Description of the Related Art

Semiconductor memory devices can be divided into volatile memory devices and nonvolatile memory devices depending on whether stored data is lost when power supply is interrupted. Storage devices that use non-volatile memory devices as storage media are widely used. A representative example of such a storage device is a solid state drive (SSD).

As the capacity of storage devices increases and the processing power of hosts improves, various workloads from hosts are provided to storage devices. The reliability of storage devices may degrade due to these various workloads. Thus, various methods for predicting reliability of information of storage devices are being studied to attempt to minimize or prevent failures in storage devices.

### SUMMARY

At least one example embodiment of the present disclosure provides a method of operating a storage device that can improve operational stability.

At least one example embodiment of the present disclosure provides a storage device performing the method.

According to example embodiments, a method of operating a storage device including a plurality of meta blocks configured to store a plurality of metadata includes receiving a first command for detecting an abnormal state of the storage device from a host device located outside the storage device. The method includes obtaining a plurality of characteristic values including a first characteristic value, a second characteristic value, a third characteristic value, a fourth characteristic value, and a degradation index for each of the plurality of meta blocks based on the first command. The first characteristic value is related to an endurance characteristic, the second characteristic value is related to a data retention characteristic, the third characteristic value is related to a read disturbance characteristic, the fourth characteristic value is related to a temperature characteristic, the degradation index is calculated from the plurality of characteristic values. The method includes outputting a first response to the host device based on at least one of the first characteristic value or the degradation index. The first response corresponds to the first command and is generated in response to the abnormal state of the storage device occurring.

According to example embodiments, a storage device includes a plurality of non-volatile memories and a storage controller. The plurality of non-volatile memories includes a plurality of meta blocks storing a plurality of metadata. The storage controller receives a first command for detecting an abnormal state of the storage device from a host device located outside the storage device. The storage controller obtains a plurality of characteristic values including a first characteristic value, a second characteristic value, a third characteristic value, a fourth characteristic value, and a degradation index for each of the plurality of meta blocks based on the first command. The first characteristic value is related to an endurance characteristic, the second characteristic value is related to a data retention characteristic, the third characteristic value is related to a read disturbance characteristic, the fourth characteristic value is related to a temperature characteristic, the degradation index is calculated from the plurality of characteristic values. The storage controller outputs a first response to the host device based on at least one of the first characteristic value and the degradation index. The first response corresponds to the first command and is generated in response to the abnormal state of the storage device occurring.

According to example embodiments, a method of operating a storage system including a host device and a storage device including a plurality of meta blocks storing a plurality of metadata includes transmitting, by the host device, a first command for detecting an abnormal state of the storage device to the storage device. The method includes obtaining, by the storage device, a plurality of characteristic values including a first characteristic value, a second characteristic value, a third characteristic value, a fourth characteristic value, and a degradation index calculated from the first to fourth characteristic values for each of the plurality of meta blocks based on the first command. The first characteristic value is related to an endurance characteristic and is obtained as a erase count (EC) percentile value, the second characteristic value is related to a data retention characteristic and is obtained as data retention time, the third characteristic value is related to a read disturbance characteristic and is obtained as a number of read operations, the fourth characteristic value is related to a temperature characteristic and is obtained as a write temperature, the degradation index is calculated from the first to fourth characteristic values. The EC percentile value is obtained by dividing an EC value by an EC limit value, the data retention time being measured from a time point at which a write operation is performed, the number of read operations is counted after the write operation is performed, the write temperature is measured while the write operation is performed. The method includes comparing, by the storage device, the degradation index for each of the plurality of meta blocks with an abnormal state standard value. The method includes, in response to the degradation index of a first meta block among the plurality of meta blocks being greater than or equal to the abnormal state standard value, transmitting, by the storage device, a first response corresponding to the first command to the host device. The method includes transmitting, by the host device, a second command for obtaining debugging information related to an abnormal state of the first meta block among the plurality of meta blocks to the storage device. The method includes transmitting, by the storage device, a second response corresponding to the second command and including the debugging information to the host device based on the second command.

In the method of operating the storage device and the storage device according to example embodiments various characteristic values and degradation index related to reliability of each of a plurality of meta blocks may be used, and an abnormal state of the storage device may be detected. By notifying the host device that an abnormal state has occurred in the storage device, operational stability of the storage device may be improved. In response to the host device being notified that the abnormal state, a function to block the command of the host trying to access the storage device may be implemented, and the storage device may be prevented from entering a fail mode. Thus, operational stability of the storage device may be improved.

### BRIEF DESCRIPTION OF THE DRAWINGS

Illustrative, non-limiting example embodiments will be more clearly understood from the following detailed description taken in conjunction with the accompanying drawings.

FIG. 1 is a flowchart illustrating a method of operating a storage device according to example embodiments.

FIG. 2 is a block diagram illustrating a storage device and a storage system including a storage device according to example embodiments.

FIG. 3 is a block diagram illustrating an example of a storage controller included in a storage device according to example embodiments.

FIG. 4 is a flowchart illustrating an example of obtaining first, second, third, and fourth characteristic values and a degradation index in a method of operating a storage device according to example embodiments.

FIGS. 5A, 5B, 6, 7A, and 7B are diagrams for describing examples of calculating a degradation index in a method of operating a storage device according to example embodiments.

FIGS. 8, 9, and 10 are flowcharts illustrating examples of outputting a first response in a method of operating a storage device according to example embodiments.

FIG. 11 is a flowchart illustrating a method of operating a storage device according to example embodiments.

FIGS. 12A and 12B are diagrams for describing a specific operation of outputting a first response in a method of operating a storage device according to example embodiments.

FIG. 13 is a flowchart illustrating a method of operating a storage device according to example embodiments.

FIGS. 14A and 14B are diagrams for describing a specific operation of outputting a second response in a method of operating a storage device according to example embodiments.

FIG. 15 is a flowchart illustrating a method of operating a storage device according to example embodiments.

FIGS. 16A and 16B are diagrams for describing a command blocking function in a method of operating a storage device according to example embodiments.

FIG. 17 is a flowchart illustrating an example of a selective command blocking function in a method of operating a storage device according to example embodiments.

FIG. 18 is a diagram for describing a command blocking function in a method of operating a storage device according to example embodiments.

FIG. 19 is a block diagram illustrating a plurality of non-volatile memories included in a storage device according to example embodiments.

FIG. 20 is a block diagram illustrating a data center to which a storage system according to example embodiments is applied.

### DETAILED DESCRIPTION OF THE EMBODIMENTS

Various example embodiments will be described more fully with reference to the accompanying drawings, in which embodiments are shown. The present disclosure may, however, be embodied in many different forms and should not be construed as limited to the embodiments set forth herein. Like reference numerals refer to like elements throughout this application.

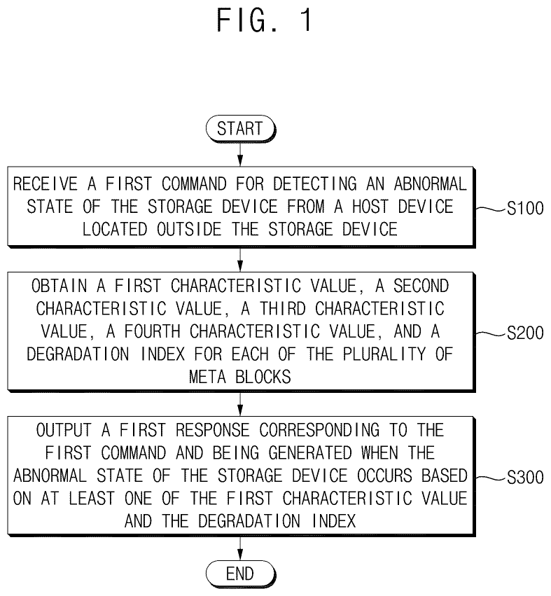

FIG. 1 is a flowchart illustrating a method of operating a storage device according to example embodiments.

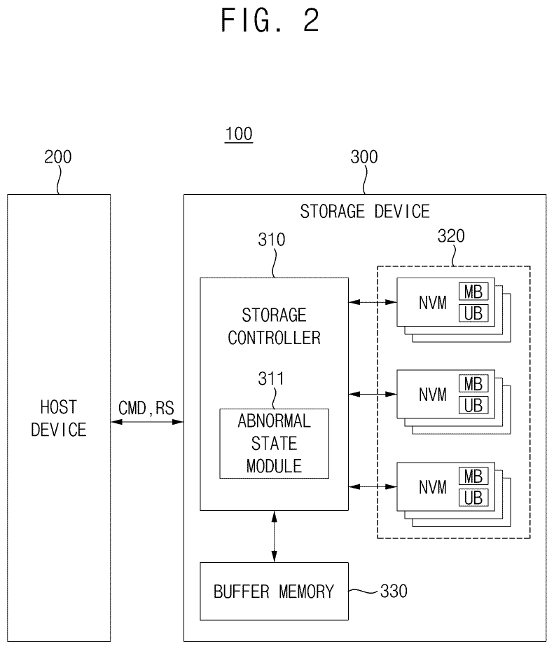

Referring to FIG. 1, a method according to example embodiments is performed by a storage device including a plurality of meta blocks storing a plurality of metadata. A structure of the storage device will be described with reference to FIG. 2.

A first command is received from an host device located outside the storage device (operation S100). The first command may be a command for detecting an abnormal state of the storage device. In some example embodiments, the first command may be an asynchronous event request (AER) command based on the non-volatile memory express (NVMe) protocol, but is not limited thereto. For example, the abnormal state of the storage device may indicate a state in which reliability of the storage device is relatively low. For example, the abnormal state may include a state in which the storage device is defective or a state before the failure occurs on the storage device. For example, the abnormal state may be defined according to individual standards by each manufacturer of the storage device.

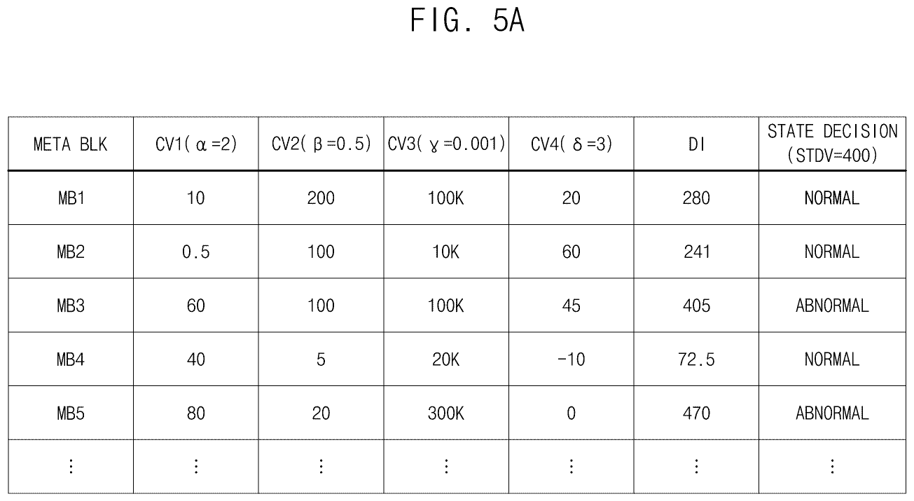

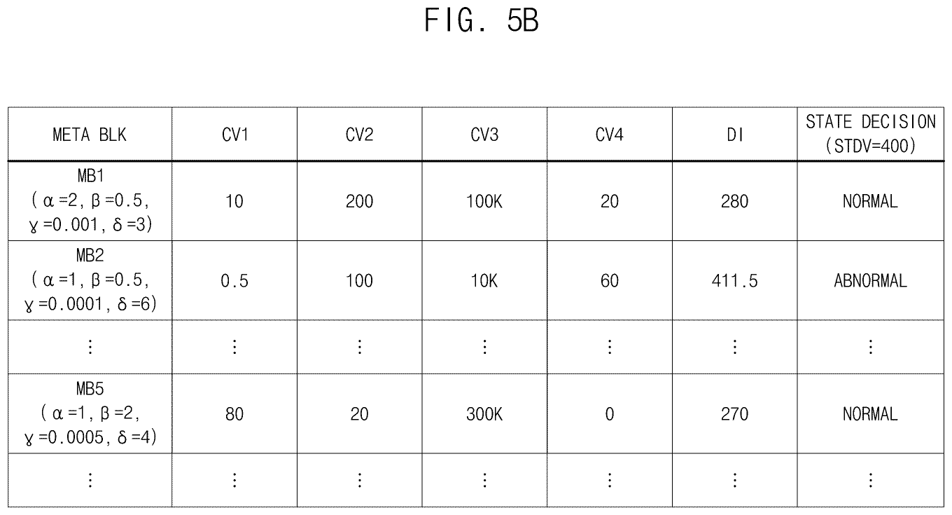

Based on the first command, a first characteristic value, a second characteristic value, a third characteristic value, a fourth characteristic value, and a degradation index are obtained for each of the plurality of meta blocks (operation S200). The first characteristic value may be related to an endurance characteristic, the second characteristic value may be related to a data retention characteristic, the third characteristic value may be related to a read disturbance characteristic, the fourth characteristic value may be related to a temperature characteristic, and the degradation index may be calculated from the first to fourth characteristic values. For example, the first to fourth characteristic values and the degradation index may be related to reliability of each of the plurality of meta blocks. Calculating the degradation index will be described in detail with reference to FIGS. 5A, 5B, 6, 7A, and 7B. For example, the first to fourth characteristic values and the degradation index may be stored in the storage device. For example, the first to fourth characteristic values and the degradation index may be stored as telemetry information.

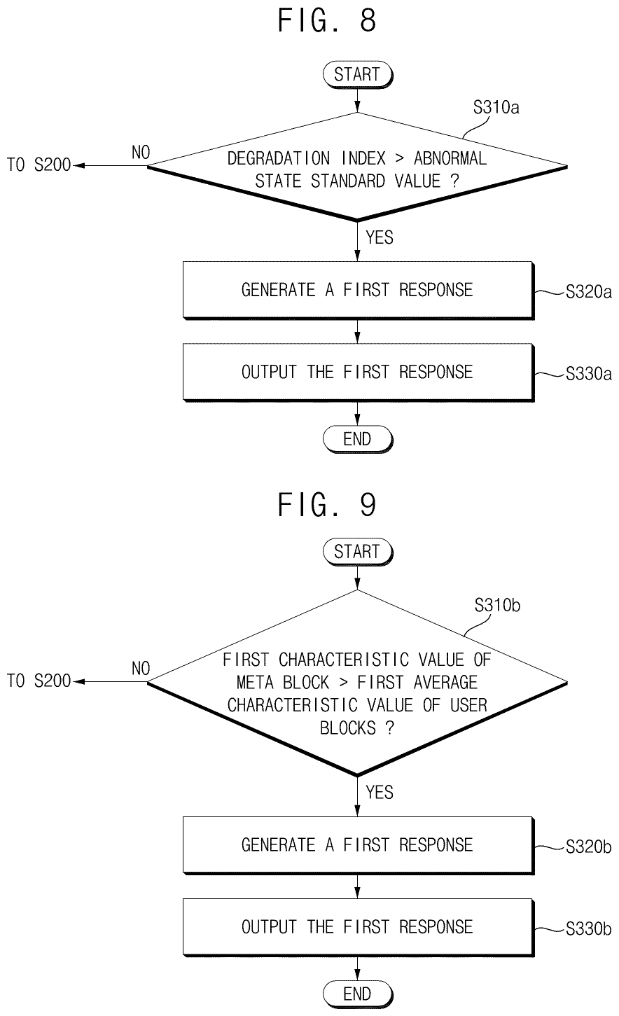

A first response corresponding to the first command is outputted (operation S300). The first response may be generated based on at least one of the first characteristic value and the degradation index, and may be outputted to the host device. The first response may indicate a case in which the abnormal state of the storage device occurs. A scheme for outputting the first response based on at least one of the first characteristic value and the degradation index will be described with reference to FIGS. 8, 9, 10, and 11. In some example embodiments, the first response may be an AER response, but is not limited thereto.

In some example embodiments, operation S100 is performed once, and then operation S200 and a portion of operation S300 may be performed periodically. In other example embodiments, operation S100 may be performed periodically, and operation S200 and a portion of operation S300 may be performed periodically based on the first command received periodically.

FIG. 2 is a block diagram illustrating a storage device and a storage system including a storage device according to example embodiments.

Referring to FIG. 2, a storage system 100 includes a host device 200 and a storage device 300.

The host device 200 may control overall operation of the storage system 100. For example, although not shown in detail, the host device 200 may include a host processor and a host memory. For example, the host processor may control operation of the host device 200 and may run an operating system (OS). For example, the host memory may store instructions and data that are executed and processed by the host processor. For example, the OS executed by the host processor may include a file system for file management and a device driver for controlling peripheral devices including the storage device 300 at OS level.

The storage device 300 may be accessed by the host device 200. The storage device 300 may include a storage controller 310, a plurality of non-volatile memories (NVMs) 320, and a buffer memory 330.

The storage controller 310 may control operation of the storage device 300. For example, the storage controller 310 may control operation of the plurality of non-volatile memories 320 based on commands and data received from the host device 200. For example, the storage controller 310 may receive and execute a command CMD from the host device 200 and transmit a response RS corresponding to the command CMD to the host device 200.

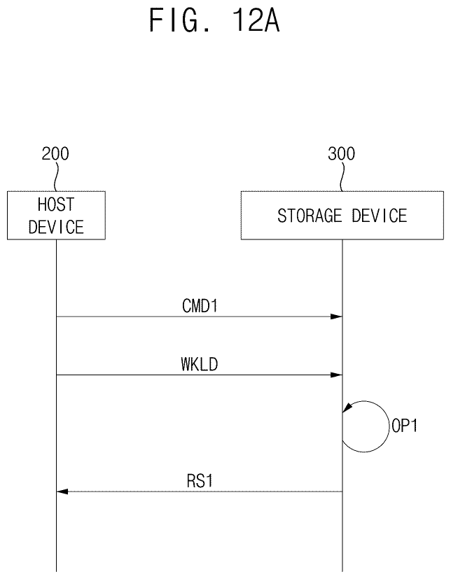

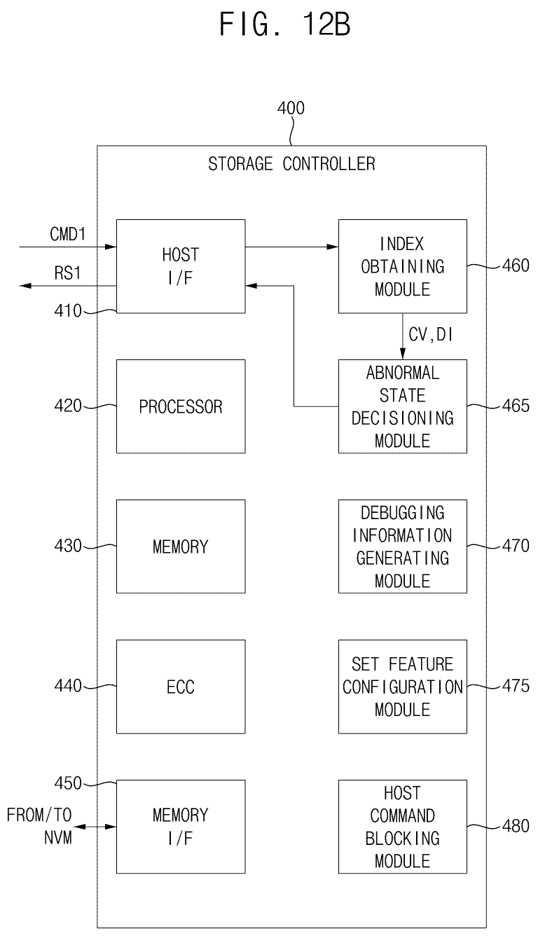

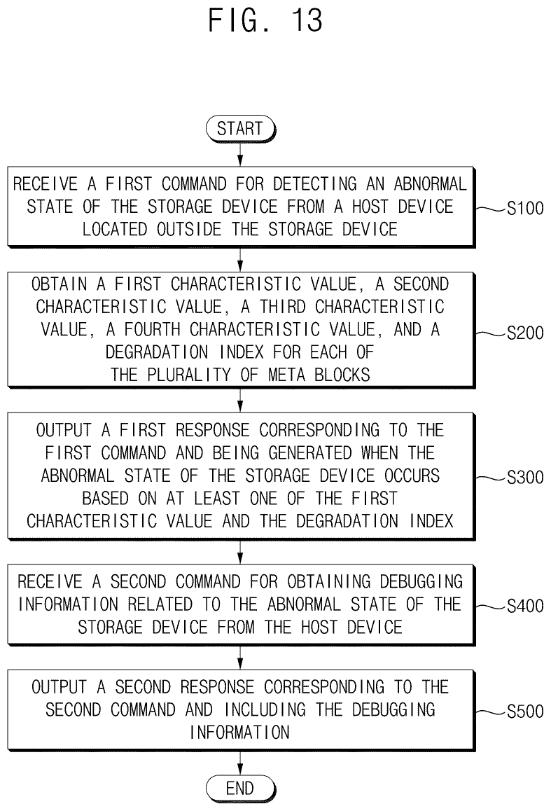

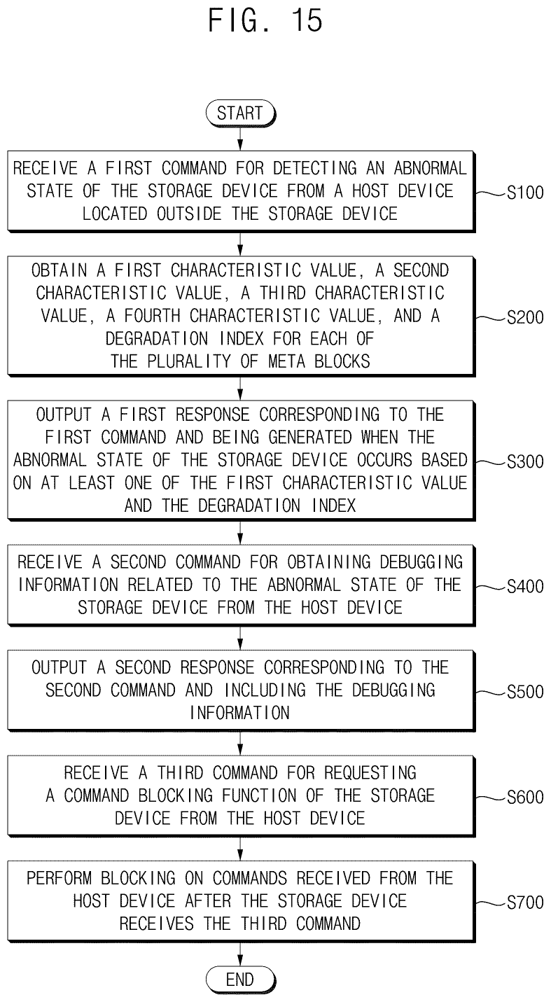

The storage controller 310 may perform a method of operating a storage device according to example embodiments described above with reference to FIG. 1. For example, the storage controller 310 may receive a first command (e.g., CMD1 in FIGS. 12A and 12B) from the host device 200 to detect an abnormal state of the storage device 300. For example, the storage controller 310 may obtain the first to fourth characteristic values and the degradation index for each of the plurality of meta blocks included in the plurality of non-volatile memories 320 based on the first command. For example, the storage controller 310 may determine whether an abnormal state has occurred in the storage device 300 based on at least one of the first characteristic value and the degradation index. For example, when an abnormal state occurs in the storage device 300, the storage controller 310 may output a first response (e.g., RS1 in FIGS. 12A and 12B) corresponding to the first command to the host device 200. The storage controller 310 may perform a method of operating a storage device according to example embodiments which will be described with reference to FIGS. 13 and 15.

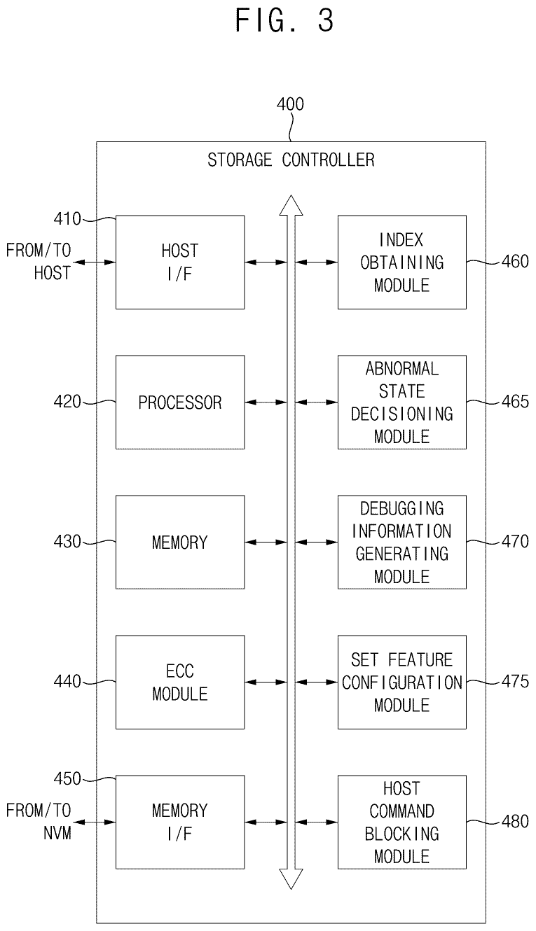

The storage controller 310 may include an abnormal state module 311 for performing a method of operating a storage device according to example embodiments. For example, as will be described with reference to FIG. 3, the abnormal state module 311 may include an index obtaining module for obtaining the first to fourth characteristic values and the degradation index, and an abnormal state decisioning module that determines whether an abnormal state has occurred in the storage device 300.

The plurality of non-volatile memories 320 may store a plurality of data. For example, the plurality of data may include a plurality of metadata and a plurality of user data. For example, the plurality of non-volatile memories 320 may include a plurality of meta blocks MB storing the plurality of metadata and a plurality of user blocks UB storing the plurality of user data.

The plurality of meta blocks MB may indicate a physical area within the plurality of non-volatile memories 320 storing the plurality of metadata. The plurality of metadata and the plurality of meta blocks MB may exist in various types depending on the purpose. For example, the plurality of metadata may include various data for managing operation of the storage device 300, such as firmware (FW)-related data, security protocol and data model (SPDM)-related data, and the like. For example, the plurality of meta blocks MB may include a FW block storing the FW-related data, a SPDM block storing the SPDM-related data, and the like.

The plurality of user blocks UB may indicate a physical area within the plurality of non-volatile memories 320 storing the plurality of user data. For example, the plurality of user data may include various data stored by user, such as document data, image data, and the like.

In some example embodiments, each of the plurality of nonvolatile memories 320 may include a NAND flash memory. In other example embodiments, each of the plurality of nonvolatile memories 320 may include one of an electrically erasable programmable read only memory (EEPROM), a phase change random access memory (PRAM), a resistive random access memory (RRAM), a nano floating gate memory (NFGM), a polymer random access memory (PoRAM), a magnetic random access memory (MRAM), a ferroelectric random access memory (FRAM), or the like.

The buffer memory 330 may store instructions and/or data that are executed and/or processed by the storage controller 310, and may temporarily store data stored in or to be stored into the plurality of nonvolatile memories 320. For example, the buffer memory 330 may include at least one of various volatile memories, e.g., a dynamic random access memory (DRAM), a static random access memory (SRAM), or the like.

In some example embodiments, the storage device 300 may be a solid state drive (SSD). In other example embodiments, the storage device 300 may be one of a universal flash storage (UFS), a multi media card (MMC), an embedded multi media card (eMMC), a secure digital (SD) card, a micro SD card, a memory stick, a chip card, a universal serial bus (USB) card, a smart card, a compact flash (CF) card, or the like.

In some example embodiments, the storage device 300 may be connected to the host device 200 through a block accessible interface which may include, for example, a UFS, an eMMC, a serial advanced technology attachment (SATA) bus, a nonvolatile memory express (NVMe) bus, a serial attached SCSI (SAS) bus, or the like. The storage device 300 may use a block accessible address space corresponding to an access size of the plurality of nonvolatile memories 320 to provide the block accessible interface to the host device 200, for allowing the access by units of a memory block with respect to data stored in the plurality of nonvolatile memories 320.

In some example embodiments, the storage system 100 may be any mobile system, such as a mobile phone, a smart phone, a tablet computer, a laptop computer, a personal digital assistant (PDA), a portable multimedia player (PMP), a digital camera, a portable game console, a music player, a camcorder, a video player, a navigation device, a wearable device, an internet of things (IoT) device, an internet of everything (IoE) device, an e-book reader, a virtual reality (VR) device, an augmented reality (AR) device, a robotic device, etc. In other example embodiments, the storage system 100 may be any computing system, such as a personal computer (PC), a server computer, a workstation, a digital television, a set-top box, a navigation system, etc.

FIG. 3 is a block diagram illustrating an example of a storage controller included in a storage device according to example embodiments.

Referring to FIG. 3, a storage controller 400 includes a host interface 410, a processor 420, a memory 430, an Error Correction Code (ECC) module 440, a memory interface 450, an index obtaining module 460, an abnormal state decisioning module 465, a debugging information generating module 470, a set feature configuration module 475, and a host command blocking module 480.

The processor 420 may control operation of the storage controller 400 in response to a command received via the host interface 410 from a host (e.g., the host device 200 in FIG. 2). In some example embodiments, the processor 420 may control respective components by employing firmware for operating a storage device (e.g., the storage device 300 in FIG. 2).

The memory 430 may store instructions and data executed and processed by the processor 420. For example, the memory 430 may be implemented with a volatile memory device with relatively small capacity and high speed, such as a static random access memory (SRAM), a cache memory, or the like.

The index obtaining module 460, the abnormal state decisioning module 465, the debugging information generating module 470, the set feature configuration module 475, and the host command blocking module 480 may be included in the abnormal state module 311 in FIG. 2.

Detailed operations of the index obtaining module 460, the abnormal state decisioning module 465, the debugging information generating module 470, the set feature configuration module 475, and the host command blocking module 480 will be described with reference to FIGS. 12B, 14B, and 16B.

In some example embodiments, at least a part of the index obtaining module 460, the abnormal state decisioning module 465, the debugging information generating module 470, the set feature configuration module 475, and the host command blocking module 480 may be implemented as hardware. For example, at least a part of the index obtaining module 460, the abnormal state decisioning module 465, the debugging information generating module 470, the set feature configuration module 475, and the host command blocking module 480 may be included in the processor 420 or may be included in a computer-based electronic circuit or logic.

In other example embodiments, at least a part of the index obtaining module 460, the abnormal state decisioning module 465, the debugging information generating module 470, the set feature configuration module 475, and the host command blocking module 480 may be implemented as instruction codes or program routines (e.g., a software program) and may be stored in a memory. For example, the processor 420 may load instructions of the index obtaining module 460, the abnormal state decisioning module 465, the debugging information generating module 470, the set feature configuration module 475, and the host command blocking module 480 into the memory 430.

The ECC block 440 for error correction may perform coded modulation using a Bose-Chaudhuri-Hocquenghem (BCH) code, a low density parity check (LDPC) code, a turbo code, a Reed-Solomon code, a convolution code, a recursive systematic code (RSC), a trellis-coded modulation (TCM), a block coded modulation (BCM), etc., or may perform ECC encoding and ECC decoding using above-described codes or other error correction codes.

The host interface 410 may provide physical connections between the host device 200 and the storage device 300. The host interface 410 may provide an interface corresponding to a bus format of the host for communication between the host device 200 and the storage device 300. In some example embodiments, the bus format of the host device 200 may be a small computer system interface (SCSI) or a serial attached SCSI (SAS) interface. In other example embodiments, the bus format of the host device 200 may be a USB, a peripheral component interconnect (PCI) express (PCIe), an advanced technology attachment (ATA), a parallel ATA (PATA), a serial ATA (SATA), a nonvolatile memory (NVM) express (NVMe), etc., format.

The memory interface 450 may exchange data with nonvolatile memories (e.g., the nonvolatile memories 320 in FIG. 2). The memory interface 450 may transfer data to the nonvolatile memories 320, or may receive data read from the nonvolatile memories 320. In some example embodiments, the memory interface 450 may be connected to the nonvolatile memories 320 via one channel. In other example embodiments, the memory interface 450 may be connected to the nonvolatile memories 320 via two or more channels.

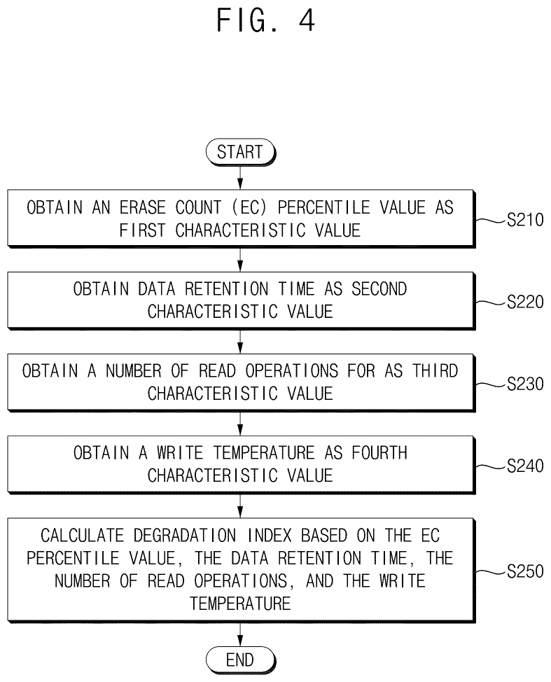

FIG. 4 is a flowchart illustrating an example of obtaining first, second, third, and fourth characteristic values and a degradation index in a method of operating a storage device according to example embodiments.

Referring to FIG. 4, operations S210, S220, S230, S240, and S250 may be an example of operation S200 in FIG. 1. For example, operations S210, S220, S230, S240, and S250 may be performed by the index obtaining module 460 in FIG. 3.

A first characteristic value may be obtained as an erase count (EC) percentile value for each of the plurality of meta blocks (operation S210). The EC percentile value may be obtained by dividing an EC value by an EC limit value. For example, the EC value may indicate the number of times an erase operation has been performed (or the number of program/erase (P/E) cycles) from manufacturing time point to present time point for each of the plurality of meta blocks. For example, the EC limit value may indicate the maximum number of times an erase operation can be performed for each of the plurality of meta blocks. For example, the plurality of meta blocks may have the same EC limit values. For example, the EC limit value may vary depending on a generation of NAND and/or a type of memory cells included in each block.

For example, the first characteristic value may be obtained in % units. For example, when the EC value and the EC limit value of a first meta block among the plurality of meta blocks are 100 times and 1000 times, respectively, the first characteristic value of the first meta block may be obtained with (100/1000)*100=10(%). For example, as program/erase operations are repeated, characteristics of the block may degrade, and therefore, the larger the first characteristic value, the lower the reliability of the block may be.

A second characteristic value may be obtained as data retention time for each of the plurality of meta blocks (operation S220). For example, the data retention time may be measured from a time point at which a write operation is performed to present time point. For example, when n (n is a positive real number) hours has elapsed since the write operation was performed on a first meta block among the plurality of meta blocks, the second characteristic value of the first meta block may be obtained as n.

A third characteristic value may be obtained as the number of read operations for each of the plurality of meta blocks (operation S230). For example, the number of read operations may be counted after the write operation is performed. For example, when the read operations are performed m (m is a positive integer) times after the write operation is performed on a first meta block among the plurality of meta blocks, the third characteristic value of the first meta block may be obtained as m.

A fourth characteristic value may be obtained as a write temperature for each of the plurality of meta blocks (operation S240). For example, the write temperature may be measured while the write operation is performed. For example, when temperature at a time point at which the write operation is performed on a first meta block among the plurality of meta blocks is k (k is an arbitrary real number) ° C., the fourth characteristic value of the first meta block may be obtained as k.

A degradation index may be calculated for each of the plurality of meta blocks based on the EC percentile value, the data retention time, the number of read operations, and the write temperature for each of the plurality of meta blocks (operation S250). For example, the degradation index may represent a composite reliability index indicating the reliability level of each of the plurality of meta blocks by comprehensively considering an endurance characteristic, a data retention characteristic, a read disturbance characteristic, and/or a temperature characteristic of the plurality of meta blocks. For example, the degradation index may represent an index used for determining an abnormal state of the storage device 300. For example, as will be described with reference to FIGS. 5A, 5B, 6, 7A, and 7B, the degradation index may be calculated in various ways, and calculating the degradation index is not limited thereto.

FIGS. 5A, 5B, 6, 7A, and 7B are diagrams for describing examples of calculating a degradation index in a method of operating a storage device according to example embodiments.

Referring to FIG. 5A, a degradation index DI for each of the plurality of meta blocks MB1, MB2, MB3, MB4, and MB5 may be calculated based on a first characteristic value CV1, a second characteristic value CV2, a third characteristic value CV3, and a fourth characteristic value CV4 for each of the plurality of meta blocks MB1, MB2, MB3, MB4, and MB5.

For example, the degradation index DI may be calculated as a sum of a first value, a second value, a third value and a fourth value. The first value may be obtained by multiplying the first characteristic value CV1 by a first weight a, the second value may be obtained by multiplying the second characteristic value CV2 by a second weight B, the third value may be obtained by multiplying the third characteristic value CV3 by a third weight y, and the fourth value may be obtained by multiplying the fourth characteristic value CV4 by a fourth weight 8.

For example, the first characteristic value CV1, the second characteristic value CV2, the third characteristic value CV3, and the fourth characteristic value CV4 of the meta block MB1 may be 10(%), 200 (hr.), 100K (times), and 20(° C.), respectively. The first value of the meta block MB1 may be obtained by multiplying the first characteristic value CV1 by the first weight α (e.g., 10*2=20), the second value of the meta block MB1 may be obtained by multiplying the second characteristic value CV2 by the second weight β (e.g., 200*0.5=100), the third value of the meta block MB1 may be obtained by multiplying the third characteristic value CV3 by the third weight γ (e.g., 100K*0.001=100), and the fourth value of the meta block MB1 may be obtained by multiplying the fourth characteristic value CV4 by the fourth weight δ (20*3=60). As a result, the degradation index DI of the meta block MB1 may be calculated as 280 (=20+100+100+60).

As will be described with reference to FIG. 8, it may be determined whether the abnormal state has occurred by comparing the degradation index DI with an abnormal state standard value STDV for each of the plurality of meta blocks MB1, MB2, MB3, MB4, and MB5. For example, when the abnormal state standard value STDV is set to 400, a state in which the degradation index DI is greater than or equal to 400 may be determined as the abnormal state.

For example, since the degradation index DI of the meta block MB1 is 280, which is less than 400, it may be determined that the abnormal state has not occurred in the meta block MB1. For example, since the degradation index DI of the meta block MB5 is 470, which is greater than 400, it may be determined that the abnormal state has occurred in the meta block MB5.

Referring to FIG. 5B, in some example embodiments, the first to fourth weights α, β, γ, and δ may be set differently for each of the plurality of meta blocks MB1, MB2, and MB5. For example, the first to fourth weights α, β, γ, and δ for the meta block MB1 in FIG. 5B may be set the same as the first to fourth weights α, β, γ, and δ for the meta block MB1 in FIG. 5A. In contrast, the first to fourth weights α, β, γ, and δ for the meta blocks MB2 and MB5 in FIG. 5B may be set differently from the first to fourth weights α, β, γ, and δ for the meta blocks MB2 and MB5 in FIG. 5A.

As the first to fourth weights α, β, γ, and δ are set differently for the meta blocks MB1, MB2, and MB5, the degradation index DI may be calculated differently as compared with the example of FIG. 5A. Thus, a decision whether the abnormal state has occurred may vary as compared with the example of FIG. 5A.

For example, in the case of the meta block MB2, in the example of FIG. 5A, when the first to fourth characteristic values CV1, CV2, CV3, and CV4 are 0.5, 100, 10K, and 60, respectively, the degradation index DI may be calculated as 241, and it may be determined that the abnormal state has not occurred. However, in the example of FIG. 5B, although the first to fourth characteristic values CV1, CV2, CV3, and CV4 are 0.5, 100, 10K, and 60, respectively, which are the same as the example in FIG. 5A, the degradation index DI may be calculated as 411.5, and it may be determined that the abnormal state has occurred.

For example, assuming that the meta block MB2 is more affected by operating temperature during a write operation of the storage device 300 and the meta block MB2 easily enters fail mode due to the operating temperature, the fourth weight δ of the meta block MB2 may be set to a higher value than the other meta blocks MB1 and MB5, and thus the degradation index DI of the meta block MB2 may be calculated as a higher value than the other meta blocks MB1 and MB5. In this case, there may be a higher chance that the meta block MB2 is determined to be in the abnormal state, so the meta block MB2 entering the fail mode may be effectively prevented.

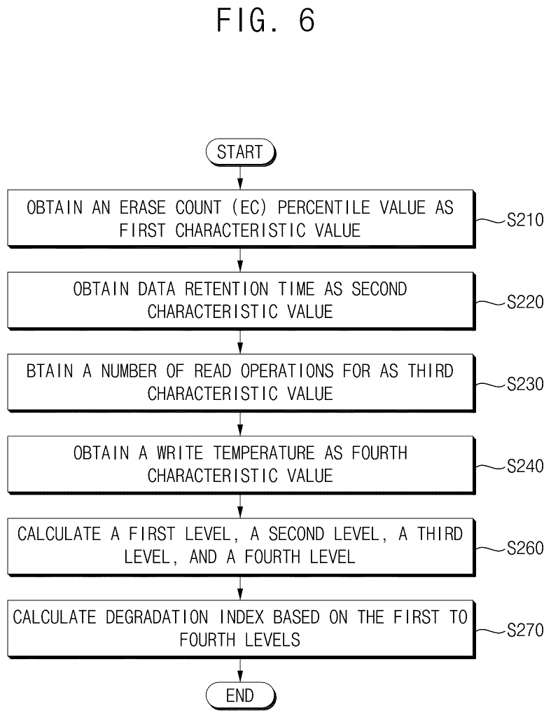

Referring to FIG. 6, operations S210, S220, S230, S240, S260, and S270 may be an example of operation S200 in FIG. 1. Operations S210, S220, S230, and S240 are substantially the same as operations S210, S220, S230, and S240 in FIG. 4, and descriptions repeated with those of FIG. 4 will be omitted.

A first level, a second level, a third level, and a fourth level may be calculated based on the first to fourth characteristic values for each of the plurality of meta blocks (operation S260). For each of the plurality of meta blocks, the degradation index may be calculated based on the first to fourth levels. For example, the degradation index may be calculated using the first to fourth levels classified by predetermined criteria, rather than using the first to fourth characteristic values directly. In this case, the degradation index may be obtained in a form similar to the first to fourth levels.

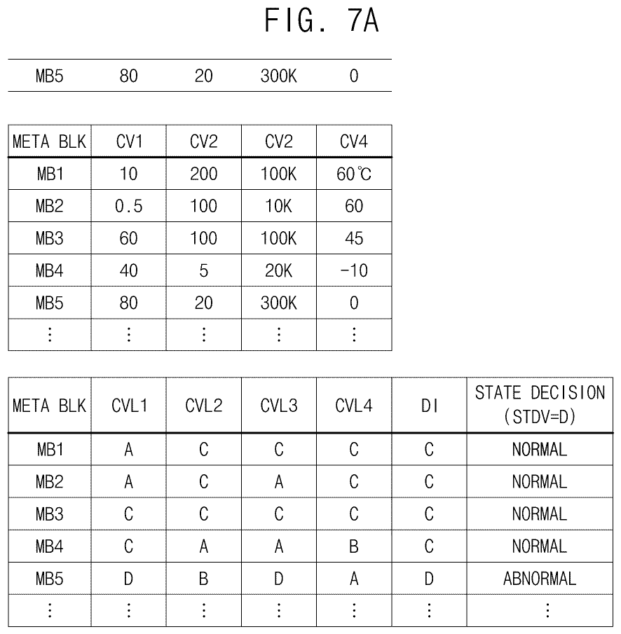

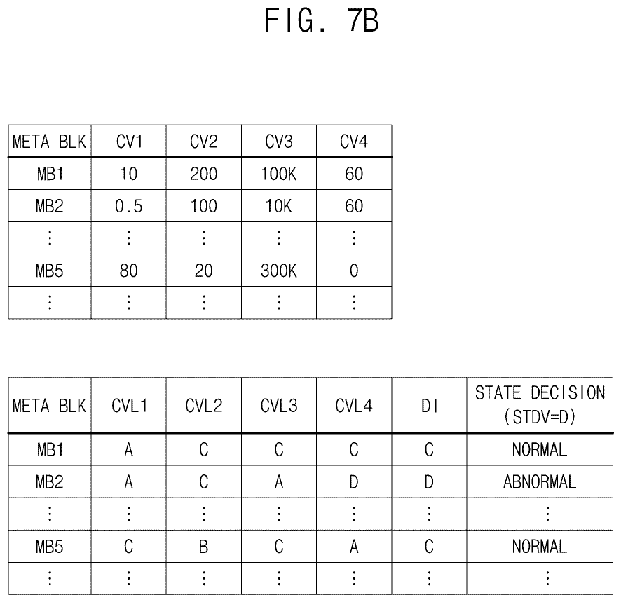

Referring to FIG. 7A, first to fourth levels CVL1, CVL2, CVL3, and CVL4 may be calculated for each of a plurality of meta blocks MB1, MB2, MB3, MB4, and MB5 as one of level A, level B, level C, and level D based on a first to fourth characteristic values CV1, CV2, CV3, and CV4. Hereinafter, it may be defined that level A is the lowest level, level B is a higher level than level A, level C is a higher level than level B, and level D is the highest level. The higher the level, the lower the reliability of the block may be. For example, a degradation index DI may be calculated based on the highest level among the first to fourth levels CVL1, CVL2, CVL3, and CVL4.

For example, the first level CVL1 may be calculated as one of A, B, C, and D. For example, the first level CVL1 may be calculated as level A if the first characteristic value CV1 is 0 to 20, the first level CVL1 may be calculated as level B if the first characteristic value CV1 is 20 to 40, the first level CVL1 may be calculated as level C if the first characteristic value CV1 is 40 to 80, and the first level CVL1 may be calculated as level D if the first characteristic value CV1 is 80 to 100. Likewise, the second to fourth levels CVL2, CVL3, and CVL4 may also be calculated based on the second to fourth characteristic values CV2, CV3, and CV4, respectively.

For example, the first characteristic value CV1, the second characteristic value CV2, the third characteristic value CV3, and the fourth characteristic value CV4 of the meta block MB1 may be 10 (%), 200 (hr.), 100K (times), 60(° C.), respectively. For example, based on the above-described criteria, the first level CVL1 of the meta block MB1 may be calculated as level A, the second level CVL2 of the meta block MB1 may be calculated as level C, the third level CVL3 of the meta block MB1 may be calculated as level C, and the fourth level CVL4 of the meta block MB1 may be calculated as level C. For example, the degradation index DI of the meta block MB1 may be calculated as level C, which is the highest level among the first level CVL1 (e.g., A), the second level CVL2 (e.g., C), the third level CVL3 (e.g., C), and the fourth level CVL4 (e.g., C) of the meta block MB1.

As will be described with reference to FIG. 8, it may be determined whether the abnormal state has occurred by comparing the degradation index DI with an abnormal state standard value STDV for each of the plurality of meta blocks MB1, MB2, MB3, MB4, and MB5. For example, when the abnormal state standard value STDV is set to level D, a state in which the degradation index DI is the same level as or a higher level than level D may be determined as the abnormal state.

For example, since the degradation index DI of the meta block MB1 is level C, which is lower than level D, it may be determined that the abnormal state has not occurred in the meta block MB1. For example, since the degradation index DI of the meta block MB5 is level D, which is same level as the abnormal state standard value STDV, it may be determined that the abnormal state has occurred in the meta block MB5.

Referring to FIG. 7B, in some example embodiments, the first to fourth levels CVL1, CVL2, CVL3, and CVL4 may be calculated based on different level distinction criteria for each of the plurality of meta blocks MB1, MB2, and MB5. In other words, a scheme by which the first to fourth levels CVL1, CVL2, CVL3, and CVL4 are calculated as one of level A, level B, level C, and level D based on the first to fourth characteristic values CV1, CV2, CV3, and CV4 may be set differently for each of the plurality of meta blocks MB1, MB2, and MB5.

For example, level distinction criteria for the meta block MB1 may be set the same as the level distinction criteria for the meta block MB1 in FIG. 7A, while level distinction criteria for the meta blocks MB2 and MB5 may be set differently from level distinction criteria for the meta blocks MB2 and MB5 in FIG. 7A.

For example, in the case of the meta block MB2, in the example of FIG. 7A, the fourth level CVL4 may be calculated as level C based on the fourth characteristic value CV4 (60), the degradation index DI may be calculated as level C, and may be determined that the abnormal state has not occurred. However, in the example of FIG. 7B, the fourth level CVL4 may be calculated as level D based on the fourth characteristic value CV4 (60), the degradation index DI may be calculated as level D, and may be determined that the abnormal state has occurred.

For example, assuming that the meta block MB2 is more affected by operating temperature during a write operation of the storage device 300 and the meta block MB2 easily enters fail mode due to the operating temperature, range of the fourth characteristic value CV4 to be classified as level D of meta block MB2 may be set wider than the ranges of other meta blocks MB1 and MB5. For example, the range of the fourth characteristic value CV4 for the fourth level CVL4 to be classified as level D of the meta block MB2 may be set to 50° C. or more, and the range of the fourth characteristic value CV4 for the fourth levels CVL4 to be classified as level D of the other meta blocks MB1 and MB5 may be set to 70° C. or higher. In this case, even though the meta block MB2 and the other meta blocks MB1 and MB5 have the same operating temperature (e.g., 60° C.), only the fourth level CVL4 of the meta block MB2 may be classified as level D. Thus, only the meta block MB2 may be determined that the abnormal state has occurred, the meta block MB2 entering the fail mode may be effectively prevented.

FIGS. 8, 9, and 10 are flowcharts illustrating examples of outputting a first response in a method of operating a storage device according to example embodiments.

Referring to FIG. 8, operations S310a, S320a, and S330a may be an example of operation S300 in FIG. 1. FIG. 8 may illustrate a case of decisioning whether the abnormal state has occurred using the degradation index.

For each of a plurality of meta blocks, the degradation index obtained as described above with reference to FIGS. 4 to 7 may be compared with the abnormal state standard value (operation S310a). For example, the abnormal state standard value may be arbitrarily set by the manufacturer, etc.

As a result of operation S310a, if the degradation index is greater than or equal to the abnormal state standard value (operation S310a: Yes), a first response may be generated (operation S320a) and the first response may be outputted to the host device 200 (operation S330a). Accordingly, if at least one of the plurality of meta blocks is determined to be in the abnormal state, the first response may be generated and may be outputted.

As a result of operation S310a, if the degradation index is less than the abnormal state standard value (operation S310a: No), operation S200 may be performed again. That is, the first to fourth characteristic values and the degradation index may be obtained again.

Referring to FIG. 9, operations S310b, S320b, and S330b may be an example of operation S300 in FIG. 1. FIG. 9 may illustrate a case of decisioning whether the abnormal state has occurred using the first characteristic value.

For each of the plurality of meta blocks, the first characteristic value may be compared with a first average characteristic value of the plurality of user blocks (operation S310b). As described above with reference to FIG. 1, the first characteristic value may indicate the EC percentile value obtained by dividing the EC value by the EC limit value. For example, the first average characteristic value may indicate an average of first characteristic values for each of the plurality of user blocks.

As a result of operation S310b, if the first characteristic value of a first meta block among the plurality of meta blocks is greater than or equal to the first average characteristic value (operation S310b: Yes), a first response may be generated (operation S320b), and the first response may be outputted to the host device 200 (operation S330b). Accordingly, if at least one of the plurality of meta blocks is determined to be in the abnormal state, the first response may be generated and outputted.

As a result of operation S310b, if the first characteristic value of the first meta block is less than the first average characteristic value (operation S310b: No), operation S200 may be performed again. That is, the first to fourth characteristic values and degradation index may be obtained again.

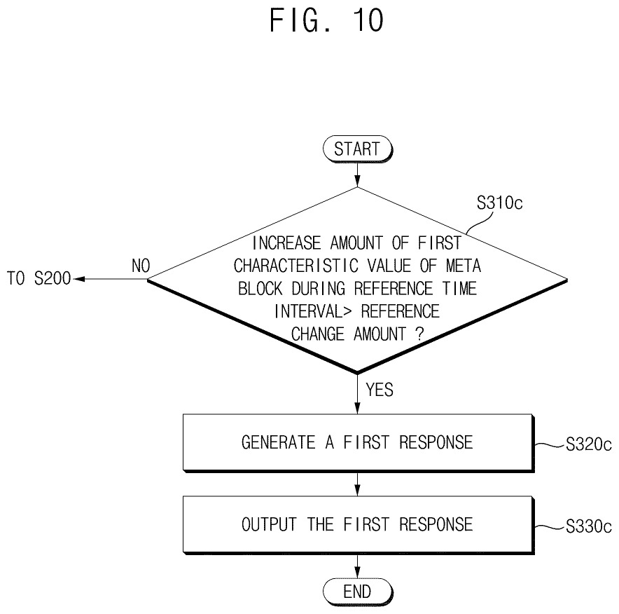

Referring to FIG. 10, operations S310c, S320c, and S330c may be an example of operation S300 in FIG. 1. FIG. 10 may illustrate a case of decisioning whether the abnormal state has occurred using the first characteristic value.

For each of the plurality of meta blocks, an increase amount of the first characteristic value of a first meta block among the plurality of meta blocks during the reference time interval may be compared with the reference change amount (operation S310c). In this case, a case where the first characteristic value rapidly increases in a short time interval may be detected.

As a result of operation S310c, if the increase amount of the first characteristic value of the first meta block during the reference time interval is greater than or equal to the reference change amount (operation S310c: Yes), a first response may be generated (operation S320c) and the first response may be outputted to the host device 200 (operation S330c). Accordingly, if at least one of the plurality of meta blocks is determined to be in the abnormal state, the first response may be generated and outputted.

As a result of operation S310c, if the increase amount of the first characteristic value of the first meta block during the reference time interval is less than the reference change amount (operation S310c: No), operation S200 may be performed again. That is, the first to fourth characteristic values and degradation index may be obtained again.

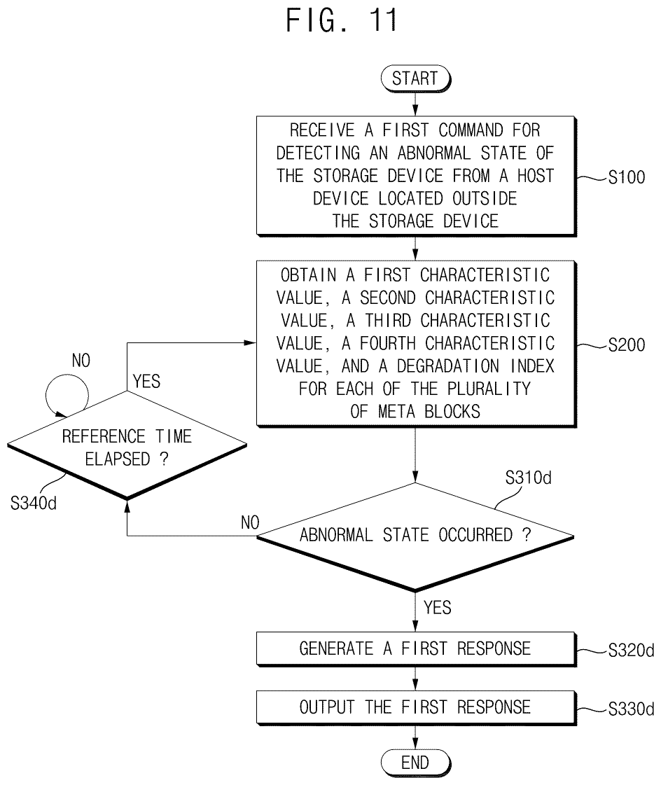

FIG. 11 is a flowchart illustrating a method of operating a storage device according to example embodiments. Descriptions repeated with those of FIG. 1 will be omitted.

Referring to FIG. 11, operations S310d, S320d, S330d, and S340d may be an example of operation S300. Operations S100 and S200 may be substantially the same as operations S100 and S200 in FIG. 1. FIG. 11 may illustrate a case where operations S200 and S310d are performed periodically

Whether the abnormal state has occurred may be determined (operation S310d). For example, operation S310d may include at least one of operations S310a, S310b, and S310c in FIGS. 8, 9, and 10.

As a result of operation S310d, if the abnormal state is determined to be occurred (operation S310d: Yes), a first response may be generated (operation S320d) and the first response may be outputted (operation S330d).

As a result of operation S310d, if the abnormal state is determined not to have occurred (operation S310d: No), whether the reference time has elapsed is checked (operation S340d), and operation S200 may be performed again only when the reference time has elapsed (operation S340d: Yes). If the reference time has not elapsed (operation S340d: No), the process may wait until the reference time has elapsed. Thus, operation S200 may be performed periodically at each reference time.

FIGS. 12A and 12B are diagrams for describing a specific operation of outputting a first response in a method of operating a storage device according to example embodiments.

Referring to FIG. 12A, signal exchange between a storage device 300 and a host device 200 corresponding to operations S100, S200, and S300 may be illustrated.

The host device 200 may transmit a first command CMD1 to the storage device 300. For example, the first command CMD1 may include an AER command.

The host device 200 may transmit various workloads WKLD to the storage device 300. The storage device 300 may perform various operations based on various workloads WKLD received after the first command CMD1 is received. For example, the various workloads WKLD may include host write/read operation, firmware download/activate, power-on reset, and power state change, or the like.

The storage device 300 may perform a first operation OP1. The first operation OP1 may be an operation for obtaining first to fourth characteristic values and a degradation index for each of the plurality of meta blocks and for determining whether the abnormal state has occurred. For example, as the storage device 300 performs various operations based on the various workloads WKLD, reliability of a plurality of meta blocks may change (e.g., degrade) by causing stress in the plurality of meta blocks. For example, the first operation OP1 may be performed periodically and may include an operation for storing the first to fourth characteristic values and the degradation index as telemetry information.

When the storage device 300 determines that the abnormal state has occurred based on at least one of the first characteristic value and the degradation index, the storage device 300 may transmit a first response RS1 corresponding to the first command CMD1 to the host device 200. For example, the first response RS1 may include AER response. For example, the first response RS1 may be generated by comparing the degradation index with an abnormal state standard value, or by comparing the first characteristic value with a first average characteristic value or a reference change amount.

Referring to FIG. 12B, a storage controller 400 may include a host interface 410, an index obtaining module 460, an abnormal state determination module 465.

The host interface 410 may receive the first command CMD1 from a host device and may transmit the first command CMD1 to the index obtaining module 460.

The index obtaining module 460 may obtain first to fourth characteristic values CV and a degradation index DI based on the first command CMD1 and transmit the first to fourth characteristic values CV and the degradation index DI to the abnormal state determination module 465.

The abnormal state determination module 465 may determine whether the abnormal state has occurred based on the first characteristic value among the first to fourth characteristic values CV and the degradation index DI and output a first response RS1 to the host device via the host interface 410.

FIG. 13 is a flowchart illustrating a method of operating a storage device according to example embodiments. Descriptions repeated with those of FIGS. 12A and 12B will be omitted.

Referring to FIG. 13, a method of operating a storage device according to example embodiments may further include operations S400 and S500 after the first response is outputted.

A second command for obtaining debugging information about the abnormal state of the storage device may be received from the host device (operation S400). The second command may be generated based on the first response. Thus, the second command may be outputted from the host device when the abnormal state occurs in the storage device.

A second response that includes debugging information of the abnormal state of the storage device and corresponds to the second command may be outputted (operation S500). For example, the debugging information may include a first meta block's type, number, the degradation index, the first characteristic value, and a first average characteristic value of the plurality of user blocks. The first meta block may be a meta block among the plurality of meta blocks in which the abnormal state occurred.

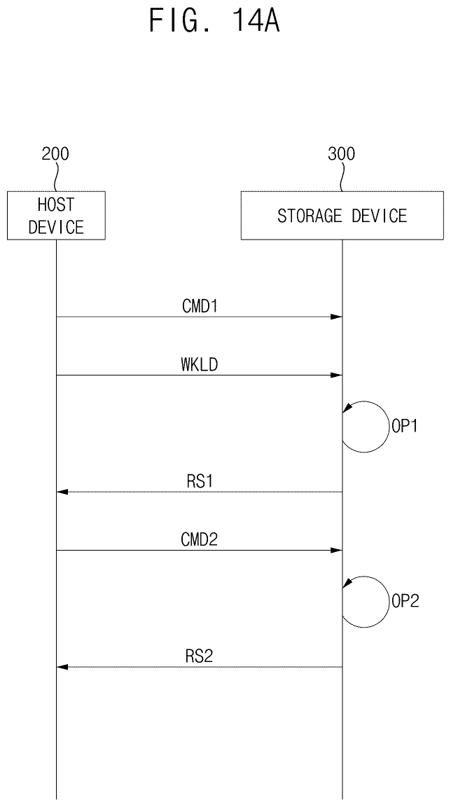

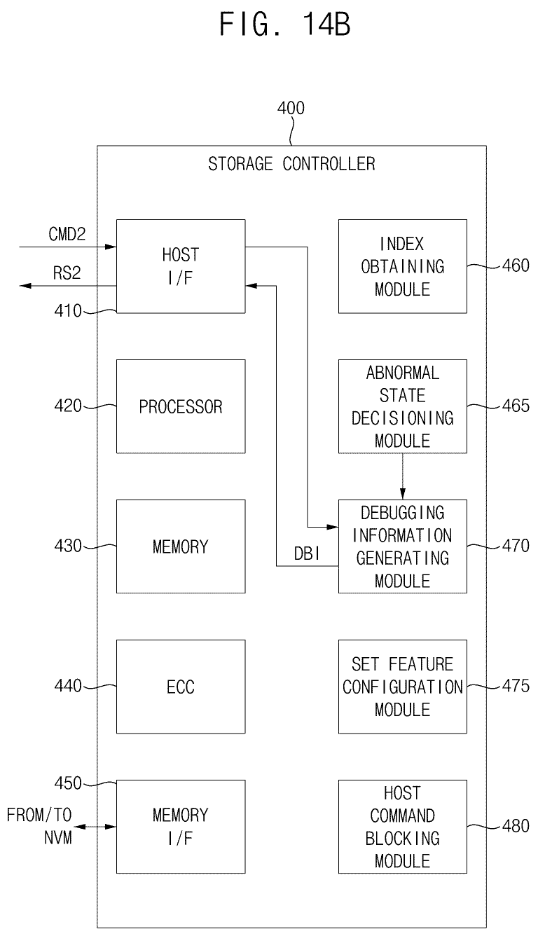

FIGS. 14A and 14B are diagrams for describing a specific operation of outputting a second response in a method of operating a storage device according to example embodiments. Descriptions repeated with those of FIGS. 12A and 12B will be omitted.

Referring to FIG. 14A, signal exchange between the storage device 300 and the host device 200 corresponding to operations S400 and S500 may be illustrated.

The host device 200 may transmit a second command CMD2 to the storage device 300. For example, the second command CMD2 may not include AER command, unlike the first command CMD1.

The storage device 300 may perform a second operation OP2 of generating debugging information. The debugging information may include the first meta block's type, number, the degradation index, the first characteristic value, and a first average characteristic value of the plurality of user blocks.

The storage device 300 may transmit a second response RS2 to the host device 200. The second response RS2 may include the debugging information and may correspond to the second command CMD2.

Referring to FIG. 14B, the storage controller 400 may include a host interface 410, a debugging information generating module 470. For example, the host interface 410 may receive the second command CMD2 from the host device and may transmit the second command CMD2 to the debugging information generating module 470.

The debugging information generating module 470 may generate debugging information DBI based on the second command CMD2. The debugging information may include the first meta block's type, number, the degradation index, the first characteristic value, and a first average characteristic value of the plurality of user blocks. For example, the debugging information generating module 470 may receive the first meta block's type, number, the degradation index, the first characteristic value, and the first average characteristic value of the plurality of user blocks from the abnormal state determination module 465. The debugging information generating module 470 may output the second response RS2 including debugging information DBI to the host device via the host interface 410.

FIG. 15 is a flowchart illustrating a method of operating a storage device according to example embodiments. Descriptions repeated with those of FIGS. 1 and 13 will be omitted.

Referring to FIG. 15, a method of operating a storage device according to example embodiments may further include operations S600 and S700 after the second response is outputted. Hereinafter, host command blocking and command blocking function are used as substantially the same meaning.

A third command for requesting a command blocking function of the storage device may be received from the host device (operation S600). For example, the third command may be generated based on the second response. For example, the third command may be implemented as a command requesting to change configuration of the storage device. For example, the storage device may be set to a command blocking mode that is distinct from a normal mode based on the third command. Although not shown in detail, in some example embodiments, when a certain period of time elapse after the command blocking mode be set, the command blocking mode may be stopped. For example, if the certain period of time has elapsed, the host device 200 may be implemented to transmit a command requesting to change the configuration of the storage device to the normal mode.

The storage device may perform blocking for commands from the host device received after the third command received (operation S700). For example, the blocking may be performed on all of the plurality of meta blocks. In some example embodiments, the blocking may be performed on all commands of the host device. In other example embodiments, the blocking may be performed selectively on commands that access the plurality of non-volatile memories among commands of the host device. Specific operation of selective host command blocking will be described with reference to FIG. 17.

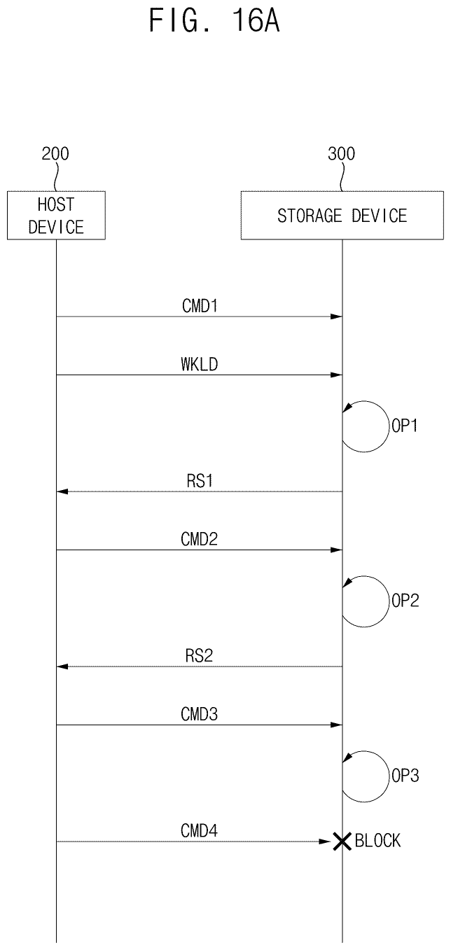

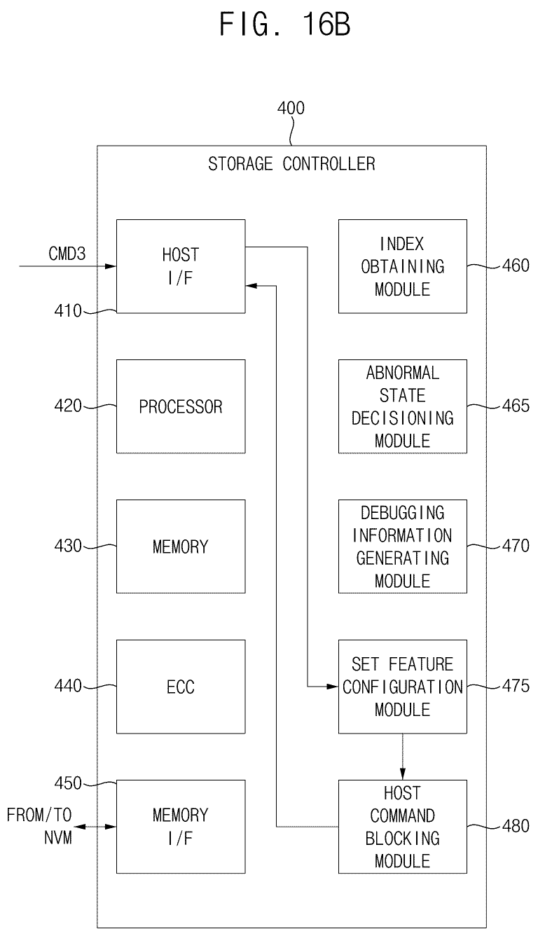

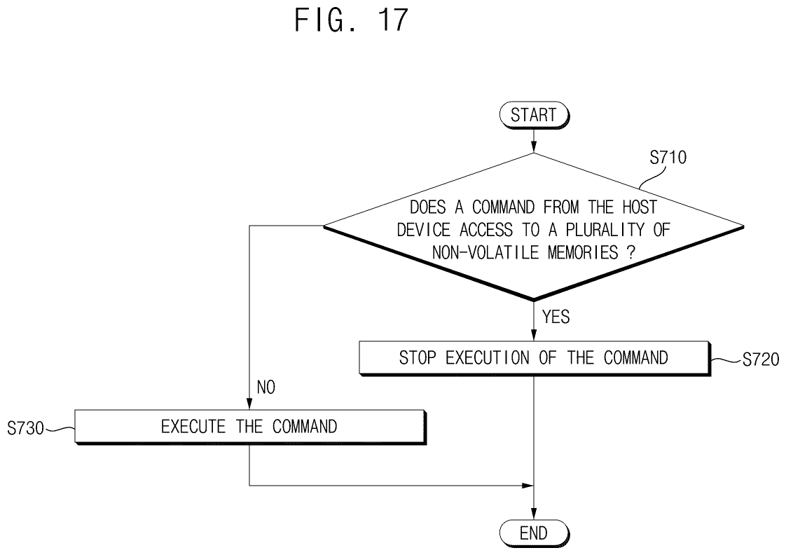

FIGS. 16A and 16B are diagrams for describing a command blocking function in a method of operating a storage device according to example embodiments. Descriptions repeated with those of FIGS. 14A and 14B will be omitted.

Referring to FIG. 16A, signal exchange between the storage device 300 and the host device 200 corresponding to operations S600 and S700 may be illustrated. The host device 200 may transmit a third command CMD3 to the storage device 300. For example, the third command CMD3 may not include AER command, unlike the first command CMD1.

The storage device 300 may perform a third operation OP3 after receiving the third command CMD3. For example, the third operation OP3 may be an operation to change configurations to block a fourth command CMD4 received from the host device after time point at which the third command is received.

Referring to FIG. 16B, the storage controller 400 may include a host interface 410, a set feature configuration module 475, a host command blocking module 480. For example, the host interface 410 may receive the third command CMD3 from the host device and may transmit the third command CMD3 to the set feature configuration module 475.

Based on the third command CMD3, the set feature configuration module 475 may configure the host command blocking module 480 to block commands from the host device after time point at which the third command is received.

When the host interface 410 receives commands from the host device, the host command blocking module 480 may block the commands from being transmitted to the processor 420.

FIG. 17 is a flowchart illustrating an example of a selective command blocking function in a method of operating a storage device according to example embodiments.

Referring to FIG. 17, whether a command of the host device is a command that accesses or does not access the plurality of non-volatile memories may be determined (operation S710). The command to access the plurality of non-volatile memories may be an example of a command that can apply stress to NAND. The command that does not access the plurality of non-volatile memories may include an admin command that reads information on a storage device.

If the command of the host device is a command that accesses the plurality of non-volatile memories (operation S710: Yes), the command may stop executing (operation S720), if the command of the host device is the command that does not access the plurality of non-volatile memories (operation S710: No), the command may be executed (operation S730). In this case, commands unrelated to the degradation of a plurality of meta blocks, including the admin command, may be executed, thereby preventing operations of the storage device from temporarily stopping completely.

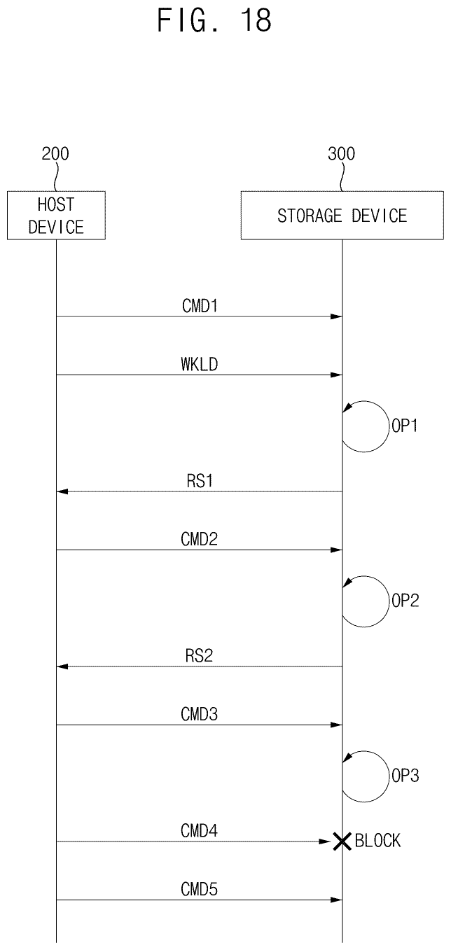

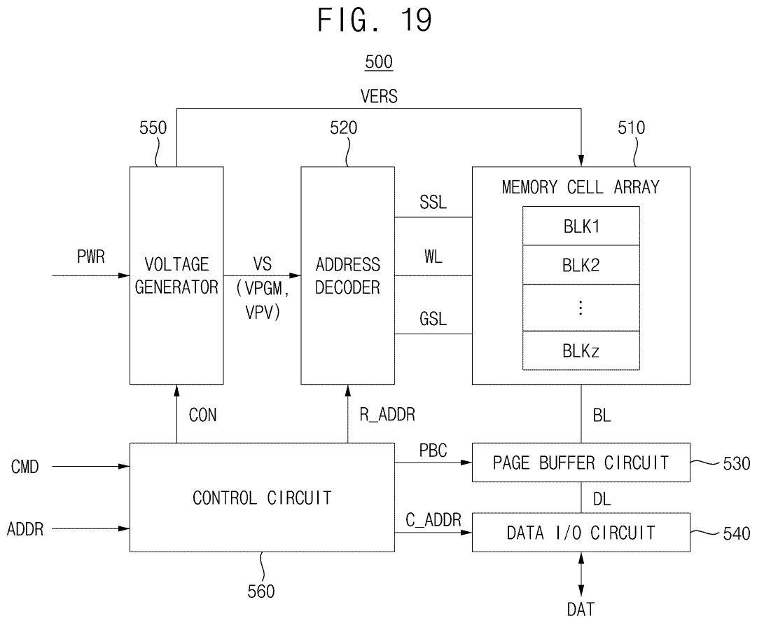

FIG. 18 is a diagram for describing a command blocking function in a method of operating a storage device according to example embodiments. Descriptions repeated with those of FIG. 16A will be omitted.

Referring to FIG. 18, signal exchange between the storage device 300 and the host device 200 corresponding to operations S710, S720, S730 may be illustrated. If a fourth command CMD4 is a command that accesses the plurality of non-volatile memory devices, the fourth command CMD4 may be blocked (or execution may be stopped). If a fifth command CMD5 is unrelated to a command that accesses the plurality of non-volatile memory devices, the fifth command CMD5 may be executed. For example, the fourth command CMD4 may indicate a command that can apply stress to NAND. For example, the fifth command CMD5 may include an admin command that reads information on the storage device.

FIG. 19 is a block diagram illustrating a plurality of non-volatile memories included in a storage device according to example embodiments.

Referring to FIG. 19, a nonvolatile memory device 500 may include a memory cell array 510, an address decoder 520, a page buffer circuit 530, a data input/output (I/O) circuit 540, a voltage generator 550, and a control circuit 560.

The memory cell array 510 is connected to the address decoder 520 via a plurality of string selection lines SSL, a plurality of wordlines WL and a plurality of ground selection lines GSL. The memory cell array 510 is further connected to the page buffer circuit 530 via a plurality of bitlines BL. The memory cell array 510 may include a plurality of memory cells (e.g., a plurality of nonvolatile memory cells) that are connected to the plurality of wordlines WL and the plurality of bitlines BL. The memory cell array 510 may be divided into a plurality of memory blocks BLK1, BLK2, . . . , BLKz each of which includes memory cells. In addition, each of the plurality of memory blocks BLK1 to BLKz may be divided into a plurality of pages. A plurality of meta blocks and a plurality of user blocks may be included in the plurality of memory blocks BLK1 to BLKz.

The control circuit 560 receives a command CMD and an address ADDR from outside (e.g., from the storage controller in FIG. 2), and controls an erasing procedure, a programming procedure and/or a read operation of the nonvolatile memory device 500 based on the command CMD and the address ADDR. An erasure procedure may include performing a sequence of erase loops, and a programming procedure may include performing a sequence of program loops. Each program loop may include a program execution operation and a program verification operation. Each erase loop may include an erase execution operation and an erase verification operation. The read operation may include a normal read operation and a data recovery read operation.

The address decoder 520 may be connected to the memory cell array 510 via the plurality of string selection lines SSL, the plurality of wordlines WL and the plurality of ground selection lines GSL. For example, in the data erase/program/read operations, the address decoder 520 may determine at least one of the plurality of wordlines WL as a selected wordline, may determine at least one of the plurality of string selection lines SSL as a selected string selection line, and may determine at least one of the plurality of ground selection lines GSL as a selected ground selection line, based on the row address R_ADDR.

The voltage generator 550 may generate voltages VS that are required for an operation of the nonvolatile memory device 500 based on a power PWR and the control signals CON. The voltages VS may be applied to the plurality of string selection lines SSL, the plurality of wordlines WL and the plurality of ground selection lines GSL via the address decoder 520. For example, the voltages VS may include a program voltage VPGM and a program verification voltage VPV required for the program loop, etc. In addition, the voltage generator 550 may generate an erase voltage VERS that is required for the data erase operation based on the power PWR and the control signals CON. The erase voltage VERS may be applied to the memory cell array 510 directly or via the bitline BL.

For example, during the program execution operation, the voltage generator 550 may apply the program voltage VPGM to the selected wordline and may apply a program pass voltage to unselected wordlines via the address decoder 520. In addition, during the program verification operation, the voltage generator 550 may apply the program verification voltage VPV to the selected wordline and may apply a verification pass voltage to the unselected wordlines via the address decoder 520.

The page buffer circuit 530 may be connected to the memory cell array 510 via the plurality of bitlines BL. The page buffer circuit 530 may include a plurality of page buffers. The page buffer circuit 530 may store data DAT to be programmed into the memory cell array 510 or may read data DAT sensed from the memory cell array 510. In other words, the page buffer circuit 530 may operate as a write driver or a sensing amplifier according to an operation mode of the nonvolatile memory device 500.

The data I/O circuit 540 may be connected to the page buffer circuit 530 via data lines DL. The data I/O circuit 540 may provide the data DAT from outside of the nonvolatile memory device 500 (e.g., from the storage controller in FIG. 2) to the memory cell array 510 via the page buffer circuit 530 or may provide the data DAT from the memory cell array 510 to the outside of the nonvolatile memory device 500 (e.g., to the storage controller in FIG. 2), based on the column address C_ADDR.

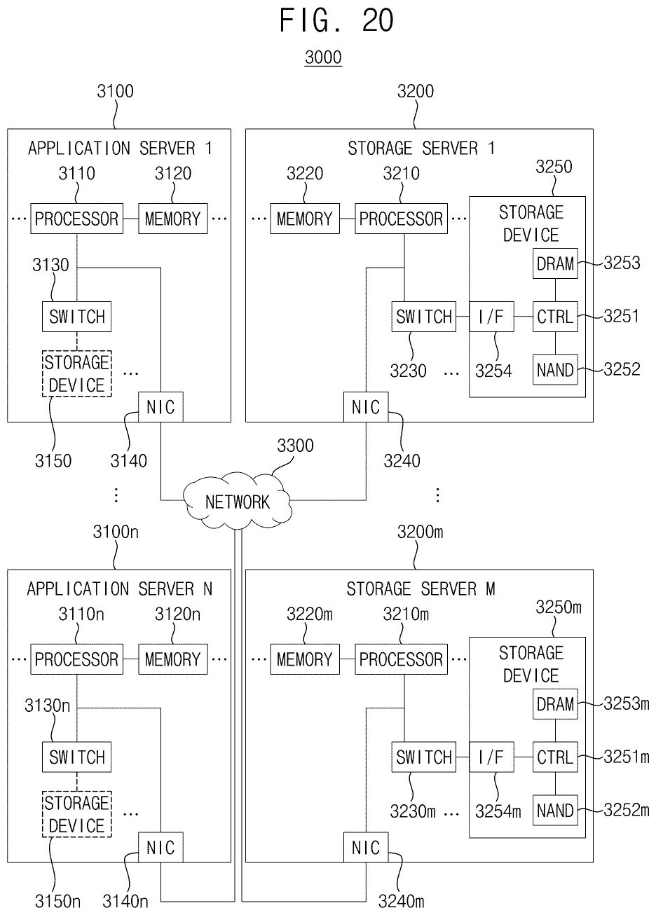

FIG. 20 is a block diagram illustrating a data center to which a storage system according to example embodiments is applied.

Referring to FIG. 20, a data center 3000 may be a facility that collects various data and provides services, and may be referred to as a data storage center. The data center 3000 may be a system for search engines and database operations, and may be a computing system used in government agencies or businesses like banks. The data center 3000 may include application servers 3100 to 3100n and storage servers 3200 to 3200m. The number of application servers 3100 to 3100n and storage servers 3200 to 3200m may vary according to example embodiments, and may differ from each other.

The application server 3100 or storage server 3200 may include at least one processor 3110 and 3210 and memory 3120 and 3220. To describe a storage server 3200 as an example, the processor 3210 may control an overall operation of the storage server 3200, may access to the memory 3220, and may execute instructions and/or data loaded in memory 3220. The memory 3220 may be Double Data Rate Synchronous DRAM (DDR SDRAM), High Bandwidth Memory (HBM), Hybrid Memory Cube (HMC), Dual In-line Memory Module (DIMM), Optane DIMM, or Non-Volatile DIMM (NVMDIMM). In some example embodiments, the number of the processors 3210 and the memories 3220 included in the storage server 3200 may vary. In some example embodiments, the processor 3210 and the memory 3220 may provide a processor-memory pair. In some example embodiments, the number of the processors 3210 and the memories 3220 may differ from each other. The processor 3210 may include a single-core processor or a multi-core processor. The above description of the storage server 3200 may also similarly apply to the application server 3100. In some example embodiments, the application server 3100 may not include a storage device 3150. The storage server 3200 may include at least one storage device 3250. The storage device 3250 may correspond to the storage device 300 in FIG. 2.

The application servers 3100 to 3100n and the storage servers 3200 to 3200m may communicate with each other through a network 3300. The network 3300 may be implemented using Fiber Channel (FC) or Ethernet. FC is a medium used for relatively high-speed data transmission and may use optical switches that provide high performance/high availability. Depending on the access method of the network 3300, the storage servers 3200 to 3200m may be provided as file storage, block storage, or object storage.

In some example embodiments, the network 3300 may be a storage-dedicated network such as Storage Area Network (SAN). For example, SAN may be an FC-SAN implemented according to the FCP (FC Protocol) using an FC network. For example, SAN may be an IP-SAN implemented according to the iSCSI (SCSI over TCP/IP or Internet SCSI) protocol using a TCP/IP network. For example, the network 3300 may be a general network such as a TCP/IP network. For example, the network 3300 may be implemented according to protocols such as FC over Ethernet (FCOE), Network Attached Storage (NAS), NVMe over Fabrics (NVMe-oF).

Hereinafter, the application server 3100 and the storage server 3200 will be mainly described. The description of application server 3100 may also apply to other application servers 3100n, and the description of storage server 3200 may also apply to other storage servers 3200m.

The application server 3100 may store data requested by a user or client to be stored in one of the storage servers 3200 to 3200m through the network 3300. The application server 3100 may obtain data requested by a user or client to be read from one of the storage servers 3200 to 3200m through the network 3300. For example, the application server 3100 may be implemented as a web server or a Database Management System (DBMS).

The application server 3100 may access to the memory 3120n or the storage device 3150n included in another application server 3100n through the network 3300, or access to the memory 3220 to 3220m or the storage device 3250 to 3250m included in the storage servers 3200 to 3200m through the network 3300. Consequently, the application server 3100 may perform various operations on data stored in the application servers 3100 to 3100n and/or the storage servers 3200 to 3200m. For example, the application server 3100 may execute a command to move or copy data between the application servers 3100 to 3100n and/or the storage servers 3200 to 3200m. The data may be moved from the storage devices 3250 to 3250m of the storage servers 3200 to 3200m, passing through the memories 3220 to 3220m of the storage servers 3200 to 3200m, or directly to the memories 3120 to 3120n of the application servers 3100 to 3100n. Data moving through the network 3300 may be encrypted for security or privacy purposes.

To describe the storage server 3200 as an example, an interface 3254 may provide a physical connection between a processor 3210 and a controller 3251, and a physical connection between a network interface connector (NIC) 3240 and the controller 3251. The controller 3251 may correspond to the storage controller 400 in FIG. 3, and the interface 3254 may correspond to the host interface 410 in FIG. 3. For example, the interface 3254 may be implemented in a Direct Attached Storage (DAS) method that connects storage device 3250 directly with a dedicated cable. For example, the interface 3254 may be implemented using various interface methods, such as Advanced Technology Attachment (ATA), Serial ATA SATA, external SATA (e-SATA), Small Computer Small Interface (SCSI), Serial Attached SCSI (SAS), Peripheral Component Interconnection (PCI), PCI express (PCIe), NVM express (NVMe), Compute eXpress Link (CXL), IEEE 1394, universal serial bus (USB), secure digital (SD) card, multi media card (MMC), embedded multi-media card (eMMC), UFS, embedded UFS (eUFS), or compact flash (CF) card interfaces, and the like.

The storage server 3200 may further include a switch 3230 and the NIC 3240. The switch 3230 may selectively connect the processor 3210 and the storage device 3250 under the control of the processor 3210, or selectively connect the NIC 3240 and the storage device 3250. Similarly, the application server 3100 may further include a switch 3130 and a NIC 3140.

In some example embodiments, the NIC 3240 may include a network interface card, a network adapter, and the like. The NIC 3240 may be connected to network 3300 through a wired interface, a wireless interface, a Bluetooth interface, an optical interface, or the like. The NIC 3240 may include internal memory, DSP, host bus interface, and may be connected to the processor 3210 and/or the switch 3230 or the like, through the host bus interface. The host bus interface may also be implemented as one of the examples of the interface 3254 described above. In some example embodiments, the NIC 3240 may be integrated with at least one of the processor 3210, the switch 3230, and the storage device 3250.

In the storage server 3200 to 3200m or the application server 3100 to 3100n, a processor may transmit a command to the storage device 3150 to 3150n and 3250 to 3250m or the memory 3120 to 3120n and 3220 to 3220m to program or read data. The data may be error-corrected data through an Error Correction Code (ECC) engine. The data may be processed with Data Bus Inversion (DBI) or Data Masking (DM) and may include Cyclic Redundancy Code (CRC) information. The data may be encrypted for security or privacy purposes.

In response to a read command received from the processor, the storage device 3150 to 3150m and 3250 to 3250m may transmit control signals and command/address signals to the NAND flash memory device 3252 to 3252m. When reading data from the NAND flash memory device 3252 to 3252m, the Read Enable (RE) signal may be input as a data output control signal and may serve to output data to the DQ bus. The Data Strobe Signal DQS may be generated using the RE signal. Command and address signals may be latched in the page buffer according to the rising or falling edge of a Write Enable (WE) signal.

The controller 3251 may control an overall operation of the storage device 3250. The controller 3251 may write data to the NAND flash 3252 in response to a write command and may read data from the NAND flash 3252 in response to a read command. For example, the write and/or read commands may be provided by a processor 3210 in the storage server 3200, a processor 3210m in another storage server 3200m, or a processor 3110 and 3110n in an application server 3100 and 3100n. The DRAM 3253 may temporarily store (buffer) data to be written to the NAND flash 3252 or data read from the NAND flash 3252. Furthermore, the DRAM 3253 may store metadata, which is user data or data generated by the controller 3251 to manage the NAND flash 3252.

The storage device 3250 to 3250m may be a storage device according to example embodiments and may perform a method of operating a storage device according to example embodiments.

Example embodiments may be applied to various electronic devices and systems, including storage devices. For example, example embodiments may be applied more efficiently to electronic systems such as personal computers, server computers, cloud computers, data centers, workstations, laptops, cellular phones, smart phones, MP3 players, personal digital assistants (PDAs), portable multimedia players (PMPs), digital TVs, digital cameras, portable game consoles, navigation devices, wearable devices, Internet of Things (IoT) devices, Internet of Everything (IoE) devices, e-books, virtual reality (VR) devices, augmented reality (AR) devices, drones, automotive systems, or the like.

The foregoing is illustrative of example embodiments and is not to be construed as limiting thereof. Although some example embodiments have been described, those skilled in the art will readily appreciate that many modifications are possible in the example embodiments without materially departing from the novel teachings and advantages of the example embodiments. Accordingly, all such modifications are intended to be included within the scope of the example embodiments as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

The term “module” is used in the description of one or more of the example embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

One or more of the elements disclosed above may include or be implemented in one or more processing circuitries such as hardware including logic circuits; a hardware/software combination such as a processor executing software; or a combination thereof. For example, the processing circuitries more specifically may include, but is not limited to, a central processing unit (CPU), an arithmetic logic unit (ALU), a digital signal processor, a microcomputer, a field programmable gate array (FGPA), a System-on-Chip (SoC), a programmable logic unit, a microprocessor, application-specific integrated circuit (ASIC), etc.

Example embodiments have been described above with the aid of method steps illustrating the performance of specified functions and relationships thereof. The boundaries and sequence of these functional building blocks and method steps have been defined herein for convenience of description. Alternate boundaries and sequences can be defined, so long as the specified functions and relationships are appropriately performed. Any such alternate boundaries or sequences are thus within the scope and spirit of the claims.

As used herein, expressions such as “at least one of,” when preceding a list of elements, modify the entire list of elements and do not modify the individual elements of the list. Thus, for example, both “at least one of A, B, or C” and “at least one of A, B, and C” mean either A, B, C or any combination of two or more of A, B, and C. Likewise, A and/or B means A, B, or A and B.

What is claimed is:

1. A method of operating a storage device including a plurality of meta blocks configured to store a plurality of metadata, the method comprising:
receiving a first command for detecting an abnormal state of the storage device from a host device located outside the storage device;
obtaining a plurality of characteristic values, wherein the plurality of characteristic values include a first characteristic value, a second characteristic value, a third characteristic value, a fourth characteristic value, and a degradation index for each of the plurality of meta blocks based on the first command, the first characteristic value being related to an endurance characteristic, the second characteristic value being related to a data retention characteristic, the third characteristic value being related to a read disturbance characteristic, the fourth characteristic value being related to a temperature characteristic, the degradation index being calculated from the plurality of characteristic values; and
outputting a first response to the host device based on at least one of the first characteristic value or the degradation index, the first response corresponding to the first command and being generated in response to the abnormal state of the storage device being detected.

2. The method of claim 1, wherein obtaining the plurality of characteristic values and the degradation index includes:
obtaining an erase count (EC) percentile value for each of the plurality of meta blocks as the first characteristic value, the EC percentile value being obtained by dividing an EC value by an EC limit value;
obtaining a data retention time for each of the plurality of meta blocks as the second characteristic value, the data retention time being measured from a time point at which a write operation is performed;
obtaining a number of read operations for each of the plurality of meta blocks as the third characteristic value, the number of read operations being counted after the write operation is performed;
obtaining a write temperature for each of the plurality of meta blocks as the fourth characteristic value, the write temperature being measured while the write operation is performed; and
calculating the degradation index for each of the plurality of meta blocks based on the EC percentile value, the data retention time, the number of read operations, and the write temperature for each of the plurality of meta blocks.

3. The method of claim 2, wherein obtaining the first characteristic value includes multiplying the EC percentile value by a first weight, obtaining the second characteristic value includes multiplying the data retention time by a second weight, obtaining the third characteristic value is obtained by multiplying the number of read operations by a third weight, obtaining the fourth characteristic value includes multiplying the write temperature by a fourth weight, and wherein the degradation index is calculated as a sum of the first characteristic value, the second characteristic value, the third characteristic value and the fourth characteristic value.

4. The method of claim 3, wherein the first to fourth weights are set differently for each of the plurality of meta blocks.

5. The method of claim 2, wherein obtaining the plurality of characteristic values and the degradation index further includes:
calculating a first level, a second level, a third level, and a fourth level for each of the plurality of meta blocks, the first level indicating a level of the first characteristic value, the second level indicating a level of the second characteristic value, the third level indicating a level of the third characteristic value, the fourth level indicating a level of the fourth characteristic value,
wherein the degradation index is calculated based on a highest level among the first to fourth levels.

6. The method of claim 5, wherein each of the plurality of meta blocks has different level distinction criteria on which calculations of the first to fourth levels are based.

7. The method of claim 1, wherein outputting the first response includes:
comparing the degradation index for each of the plurality of meta blocks with an abnormal state standard value; and
when the degradation index of a first meta block among the plurality of meta blocks is greater than or equal to the abnormal state standard value, generating the first response.

8. The method of claim 1,
wherein the storage device further includes a plurality of user blocks configured to store a plurality of user data,
wherein outputting the first response includes:
comparing the first characteristic value for each of the plurality of meta blocks with a first average characteristic value related to an endurance characteristic of the plurality of user blocks; and
in response to determining that the first characteristic value of a first meta block among the plurality of meta blocks is greater than or equal to the first average characteristic value, generating the first response.

9. The method of claim 1, wherein outputting the first response includes:
in response to determining that the first characteristic value of a first meta block among the plurality of meta blocks increases by more than a reference change amount during a reference time interval, generating the first response.

10. The method of claim 1, further comprising:
receiving a second command for obtaining debugging information related to an abnormal state of a first meta block among the plurality of meta blocks from the host device; and
outputting a second response to the host device based on the second command, the second response corresponding to the second command and including the debugging information.

11. The method of claim 10, wherein the debugging information includes at least one of a meta block type, a number of meta blocks, the degradation index, or the first characteristic value of the first meta block.

12. The method of claim 10, further comprising:
receiving a third command for requesting a command blocking function of the storage device from the host device; and
in response to the storage device receiving the third command, blocking a plurality of commands received from the host device based on the third command.

13. The method of claim 12,
wherein the storage device includes a plurality of non-volatile memories,
wherein blocking the plurality of commands includes,
in response to receiving a fourth command related to accessing the plurality of non-volatile memories, stopping execution of the fourth command; and
in response to receiving a fifth command unrelated to accessing the plurality of non-volatile memories, executing the fifth command.

14. The method of claim 1,
wherein the first command includes an asynchronous event request (AER) command, and
wherein the first response includes an AER response.

15. The method of claim 1, wherein obtaining the plurality of characteristic values and the degradation index is performed periodically.

16. The method of claim 1, wherein the plurality of characteristic values and the degradation index are stored as telemetry information.

17. The method of claim 1, wherein the storage device is a solid state drive (SSD).

18. A storage device comprising:
a plurality of non-volatile memories including a plurality of meta blocks configured to store a plurality of metadata; and
a storage controller configured to
receive a first command for detecting an abnormal state of the storage device from a host device located outside the storage device,
obtain a plurality of characteristic values, including a first characteristic value, a second characteristic value, a third characteristic value, a fourth characteristic value, and a degradation index for each of the plurality of meta blocks in response to receiving the first command, and
output a first response to the host device based on at least one of the first characteristic value or the degradation index, wherein
the first characteristic value being related to an endurance characteristic,
the second characteristic value being related to a data retention characteristic,
the third characteristic value being related to a read disturbance characteristic,
the fourth characteristic value being related to a temperature characteristic,
the degradation index being calculated from the plurality of characteristic values, and
the first response corresponding to the first command and being generated in response to the abnormal state of the storage device being detected.

19. The storage device of claim 18, wherein the storage controller includes:
an index obtaining module configured to calculate and store the plurality of characteristic values and the degradation index; and
an abnormal state decisioning module configured to compare the degradation index for each of the plurality of meta blocks with an abnormal state standard value, and configured to generate the first response in response to the degradation index of a first meta block among the plurality of meta blocks being greater than or equal to the abnormal state standard value,
wherein, for each of the plurality of meta blocks, the index obtaining module is further configured to obtain an erase count (EC) percentile value for each of the plurality of meta blocks as a first characteristic value, configured to obtain data retention time for each of the plurality of meta blocks as a second characteristic value, configured to obtain a number of read operations for each of the plurality of meta blocks as a third characteristic value, configured to obtain a write temperature for each of the plurality of meta blocks as a fourth characteristic value, and configured to calculate the degradation index for each of the plurality of meta blocks based on the EC percentile value, the data retention time, the number of read operations, and the write temperature for each of the plurality of meta blocks, the EC percentile value being obtained by dividing an EC value by an EC limit value, the data retention time being measured from a time point at which a write operation is performed, the number of read operations being counted after the write operation is performed, and the write temperature being measured while the write operation is performed.

20. A method of operating a storage system including a host device and a storage device including a plurality of meta blocks configured to store a plurality of metadata, the method comprising:
transmitting, by the host device, a first command for detecting an abnormal state of the storage device to the storage device;
obtaining, by the storage device, a plurality of characteristic values including a first characteristic value, a second characteristic value, a third characteristic value, and a fourth characteristic value, and a degradation index calculated from the plurality of characteristic values for each of the plurality of meta blocks based on the first command, the first characteristic value being related to an endurance characteristic and being obtained as a erase count (EC) percentile value, the second characteristic value being related to a data retention characteristic and being obtained as data retention time, the third characteristic value being related to a read disturbance characteristic and being obtained as a number of read operations, the fourth characteristic value being related to temperature characteristic and being obtained as a write temperature, the degradation index being calculated from the first to fourth characteristic values, the EC percentile value being obtained by dividing an EC value by an EC limit value, the data retention time being measured from a time point at which a write operation is performed, the number of read operations being counted after the write operation is performed, the write temperature being measured while the write operation is performed;
comparing, by the storage device, the degradation index for each of the plurality of meta blocks with an abnormal state standard value;
in response to the degradation index of a first meta block among the plurality of meta blocks being greater than or equal to the abnormal state standard value, transmitting, by the storage device, a first response corresponding to the first command to the host device.
transmitting, by the host device, a second command for obtaining debugging information related to an abnormal state of the first meta block among the plurality of meta blocks to the storage device; and
transmitting, by the storage device, a second response corresponding to the second command and including the debugging information to the host device based on the second command.
